(19) United States
(12) Patent Application Publication
(10) Pub. No.: US 2013/0197119 A1
(43) Pub. Date: Aug. 1, 2013

(54) MICROCELLULAR FOAM MOLDING OF AIRCRAFT INTERIOR COMPONENTS

(71) Applicants: Sydney Robert STAPLETON, Seattle, WA (US); Michael D. HAMM, Sammamish, WA (US); James David SKLENKA, Stafford Springs, CT (US)

(72) Inventors: Sydney Robert STAPLETON, Seattle, WA (US); Michael D. HAMM, Sammamish, WA (US); James David SKLENKA, Stafford Springs, CT (US)

(73) Assignee: VAUPELL HOLDINGS, INC., Seattle, WA (US)

(21) Appl. No.: 13/567,521

(22) Filed: Aug. 6, 2012

Related U.S. Application Data
(60) Provisional application No. 61/515,120, filed on Aug. 4, 2011.

(51) Int. Cl. B29C 44/00

(52) U.S. Cl. CPC B29C 44/00
USPC 521/180; 264/41; 521/189; 521/183

(57) ABSTRACT

An article comprising: a monolithic, single layer, rigid thermoplastic interior component for an aircraft, wherein the thermoplastic interior component has a microcellular foam structure, wherein the thermoplastic interior component has an average two minute heat release of less than or equal to 65 kw-min/m² when tested in accordance with the requirements of FAR 25.853 (d), Appendix F, Part IV through Amendment 25-116; and wherein the thermoplastic interior component has an average peak heat release of less than or equal to 65 kw/m² when tested in accordance with the requirements of FAR 25.853 (d), Appendix F, Part IV through Amendment 25-116.

### CROSS REFERENCE TO RELATED APPLICATIONS

The application claims the benefit of U.S. Provisional Application No. 61/515,120 filed Aug. 4, 2011.

### FIELD OF INVENTION

The present disclosure relates to aircraft interior components and microcellular foam molding of such components.

### BACKGROUND

Thermoplastic injection molded aircraft interior components have requirements and/or objectives beyond what is typically be required of other injection molded parts, such as disposable components or components that may be hidden from view. For example, it is desirable that aircraft interior parts are light weight, meet or exceed safety requirements of FAR 25.853 and/or meet or exceed the heat-release standard OSU 65/65. Furthermore, it may be desirable that the as-molded surface finish results in an acceptable painted finish without mechanical surface preparation (beyond cleaning) as the molded parts may be painted to match other interior components.

One method of reducing part weight may include foaming while forming the part. While foaming processes may improve flow characteristics during processing, many drawbacks exist with regard to the foaming process. For example, prior to the present invention, it was not expected that safety requirements of FAR 25.853 and the heat-release standard OSU 65/65 would be met by foamed (using the MUCELL™ microcellular foaming process) thermoplastic parts, even when molded with a material that meets the above specifications in a non-foamed configuration. In particular, the increased surface area to volume associated with a foamed material would be expected to increase the flammability and heat release.

Furthermore, it was not expected, prior to the present invention, that foamed parts, particularly formed from materials that would satisfy the above safety requirements, would also provide the aesthetic characteristics acceptable for an interior aircraft applications. The surface finish of parts produced using microcellular foam processes may display surface imperfections that may be transmitted through a standard priming and painting process used in the aircraft interiors market. Furthermore, the paint curing process at elevated temperature may result in additional surface blemishes as the captured gas in the foam structure expands during the curing processes.

### SUMMARY

An article is provided, comprising a thermoplastic interior component for an aircraft, wherein the thermoplastic interior component has a microcellular foam structure, wherein the thermoplastic interior component has an average two minute heat release of less than or equal to 65 kw-min/m² when tested in accordance with the requirements of FAR 25.853 (d), Appendix F, Part IV through Amendment 25-116; and wherein the thermoplastic interior component has an average peak heat release of less than or equal to 65 kw/m² when tested in accordance with the requirements of FAR 25.853 (d), Appendix F, Part IV through Amendment 25-116.

The thermoplastic interior component may be formed from a material composition having a melt flow index in the range of 1.0 g/10 min to 20.0 g/10 min when measured at 295° C./6.6 kgf in accordance with the requirements of ASTM D-1238-10.

The thermoplastic interior component may be formed from a material composition having a melt volume rate of 60 cm³/10 min to 70 cm³/10 min when measured at 360° C./5 kg in accordance with the requirements of ASTM D-1238-10.

The thermoplastic interior component may be formed from a material composition having a glass transition temperature greater than or equal to 50° C.

The thermoplastic interior component may be formed from a material composition comprising at least one polymer including polyetherimide, polyether ether ketone, polyimide, polyphenylene sulfide, polyphenylene sulfone, polyphenylsulfone, and polycarbonate.

The thermoplastic interior component may be formed from a material composition comprising at least one copolymer, or a blend of two or more polymers, such as polyetherimide and polycarbonate.

The thermoplastic interior component may exhibit a weight reduction of 5% to 20% relative to a solid component of a same geometry formed from a same material without the microcellular foam structure.

The thermoplastic interior component may be an injection molded component or an extruded component.

The thermoplastic interior component may have an average time to peak heat release of more than 80 seconds when tested in accordance with the requirements of FAR 25.853 (d), Appendix F, Part IV through Amendment 25-116.

The thermoplastic interior component may further have an average two minute heat release of less than or equal to 50, 35, 20 or 5 kw-min/m² when tested in accordance with the requirements of FAR 25.853 (d), Appendix F, Part IV through Amendment 25-116.

The thermoplastic interior component may further have an average peak heat release of less than or equal to 50, 35 or 25 kw/m² when tested in accordance with the requirements of FAR 25.853 (d), Appendix F, Part IV through Amendment 25-116.

A method of forming an article is provided, comprising forming a rigid thermoplastic interior component for an aircraft, wherein the thermoplastic interior component has a microcellular foam structure, wherein the thermoplastic interior component has an average two minute heat release of less than or equal to 65 kw-min/m² when tested in accordance with the requirements of FAR 25.853 (d), Appendix F, Part IV through Amendment 25-116; and wherein the thermoplastic interior component has average peak heat release of less than or equal to 65 kw/m² when tested in accordance with the requirements of FAR 25.853 (d), Appendix F, Part IV through Amendment 25-116.

### BRIEF DESCRIPTION OF THE DRAWINGS

The above-mentioned and other features of this disclosure, and the manner of attaining them, may become more apparent and better understood by reference to the following description of embodiments described herein taken in conjunction with the accompanying drawings, wherein:

FIG. 1 illustrates a top perspective view of an injection molded test part; and

FIG. 2 illustrates a bottom perspective view of an injection molded test part.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

The present disclosure relates to aircraft interior components and a method of forming such components utilizing microcellular foam molding processes. As noted above, thermoplastic molded aircraft interior components are subject to requirements and/or objectives beyond what is typically required of other injection molded parts, such as disposable goods or parts that may be used in applications where the parts may remain hidden from view. Such requirements may include being relatively lightweight, meeting the safety requirements of FAR 25.853 and meeting the heat-release standard OSU 65/65. Further, as most parts may be painted, it may be desirable that the as-molded surface finish result in an acceptable painted finish without mechanical surface preparation (beyond cleaning).

The materials utilized herein to form the aircraft interior components may include thermoplastic materials that may be used in various thermoplastic molding processes, such as injection molding or extrusion. In addition, as alluded to above, the materials may include those which, when foamed with supercritical fluid, remain fire-smoke-toxicity compliant meeting FAR 25.853 and OSU 65/65. FAR 25.853 may also be referred to as 14 CFR 25.853, as amended by Amendment 25-83, 60 FR 6623, Feb. 2, 1995, as amended by Amendment 25-116, 69 FR 62788, Oct. 27, 2004, which is hereby incorporated by reference in its entirety.

As may be understood, OSU 65/65 in captured in FAR 25.853 (d), which requires certain interior components (not seat cushions, which are captured in FAR 25.853 (c)) of airplanes with passenger capacities of 20 or more to meet the test requirements of Parts IV and V of Appendix F of Part 25. Part IV requires a total positive heat release over the first two minutes of exposure for each of three or more samples tested to be averaged, and a peak heat release rate for each of the samples must be averaged. The average total heat release must not exceed 65 kilowatt-minutes per square meter, and the average peak heat release rate must not exceed 65 kilowatts per square meter.

The materials may preferably exhibit a melt flow index in the range of 1.0 g/10 min. to 20.0 g/10 min., and more particularly in the range of 1.0 g/10 min. to 9.0 g/10 min. when measured at 295° C./6.6 kgf, including all values or increments therein, and a melt volume rate, at 360° C./5 kg, of 60-70 cm³/10 min when measured in accordance with the requirements of ASTM D-1238-10. The candidate materials may also include those materials that have a glass transition temperature (Tg) of greater than or equal to 50° C., and more particularly greater than or equal to 150° C. Such materials may therefore include polyetherimides, aromatic polyketone type polymers such as polyether ether ketone (PEEK), polyimides, polyphenylene sulfide, polyphenylene sulfone, polyphenylsulfone, blends and copolymers thereof. In one embodiment, the materials may preferably include blends of polyetherimide and polycarbonate. In particular embodiments, ULTEM 9085, a polyetherimide/polycarbonate blend (available from SABIC Innovative Polymers) may be employed. The foregoing materials all may be understood as being rigid thermoplastics, having a modulus of elasticity either in flexure or in tension greater than 700 MPa at 23° C. and 50% relative humidity when tested in accordance with ASTM methods D790 or D638.

Properties of ULTEM 9085 obtained from SABIC are as follows:
Physical, Mechanical and Thermal Properties

| Specific Gravity | 1.34 | g/cc | ASTM D792 |
|---|---|---|---|
| Melt Flow Rate, 295° C./6.6 kgf | 8.9 | g/10 min | ASTM D1238 |
| Melt Volume Rate at 360° C./5.0 kg | 65 | cm3/10 min | ISO 1133 |
| Tensile Strength at Break | 74 | MPa | Type I, 5 mm/min; ASTM D638 |
| Tensile Strength, Yield | 84 | MPa | Type I, 5 mm/min; ASTM D638 |
| Elongation at Break | 72% | | Type I, 5 mm/min; ASTM D638 |
| Elongation at Yield | 7% | | Type I, 5 mm/min; ASTM D638 |
| Tensile Modulus | 3.44 | GPa | 5 mm/min; ASTM D638 |
| Flexural Modulus | 2.92 | GPa | 1.3 mm/min, 50 mm span; |
| | | | ASTM D790 |
| Flexural Yield Strength | 138 | MPa | 1.3 mm/min, 50 mm span; |
| | | | ASTM D790 |
| Deflection Temperature at 1.8 | 153° C. @ 3.2 | | Unannealed; ASTM D648 |
| MPa (264 psi) | mm thickness | | |
| Vicat Softening Point | 173° | C. | Rate B/120; ISO 306 |

Flame Characteristics

| FAA Flammability, FAR 25.853 | <5 | | FAR 25.853 |
|---|---|---|---|
| A/B | | | |
| OSU total heat release (2 minute | 16 | kw-min/m | FAR 25.853 |
| test) | | | |
| OSU peak heat release rate (5 | 36 | kw/m² | FAR 25.853 |
| minute test) | | | |
| Vertical Burn a (60 s) passes at | 2 | sec | FAR 25.853 |

Injection Molding Processing Conditions

| Nozzle Temperature | 330-350° | C. |
|---|---|---|
| Rear - Zone 1 | 314-340° | C. |
| Middle - Zone 2 | 325-345° | C. |
| Front - Zone 3 | 330-350° | C. |
| Melt Temperature | 330-350° | C. |
| Mold Temperature | 120-150° | C. |
| Drying Temperature | 135° | C. |
| Dry Time | 4-6 | hours |
| Moisture Content | <0.02% | |
| Back Pressure | 0.3-0.7 | MPa |
| Shot Size | 40-60% | |
| Screw Speed | 40-70 | rpm |

Unless otherwise indicated, the test method employed is understood to be the most recent version of the test method available at the time of filing this application.

The materials may be processed into aircraft parts through microcellular molding processes. Microcellular molding may be understood as a process wherein a physical foaming agent, such as a supercritical fluid including nitrogen or carbon dioxide, is introduced into a thermoplastic melt. The temperature and or pressure may be controlled allowing the supercritical fluid to dissolve into the thermoplastic melt and initially avoid foam cell nucleation. The material may then be injected into a molding cavity or formed in die, wherein the pressure may be released and cell nucleation may occur. Average closed cell size (diameter) may be in a range of 5-100 microns including all values or increments therein. More particularly, average closed cell size (diameter) may be in a range of 5-50 microns including all values or increments therein. Even more particularly, average closed cell size (diameter) may be in a range of 20-50 microns including all values or increments therein. The thermoplastic material may then be cooled preserving the microcellular structure. One example of such a process includes what is known as the MUCELL™ microcellular foaming process, available from TREXEL, INC.

In particular embodiments, the thermoplastic material may be injection molded while using the microcellular molding process. Injection molding may be understood as a process wherein the viscosity of a thermoplastic material may be reduced to allow the thermoplastic material to flow via mechanical action, elevated pressures, elevated temperatures and combinations thereof. Once the thermoplastic material is flowable or forms a melt, the material may then be transferred into a cavity forming the part or a providing a geometry, which may then be machined to form the final part. In utilizing the microcellular molding process, 25% less injection pressure may now be utilized as compared to molding a solid part of the same geometry utilizing the same material.

Once molded, the parts may then be finished such as by further machining or painting. The parts herein may now be utilized in various interior aircraft applications, including, seatbacks, tray tables, arm rests, molding, door panels, wall panels, etc.

The foamed parts herein may exhibit a weight reduction in the range of 5% to 20% relative to solid parts of the same geometry formed from the same material, including all values and ranges therein. Furthermore, the parts may exhibit no discernable sink marks in surfaces opposing ribs of the same thickness or greater than the nominal thickness of the part wall. In addition the parts, with the indicated weight reduction, may now also satisfy the safety requirements of FAR 25.853 and OSU 65/65.

### EXAMPLE

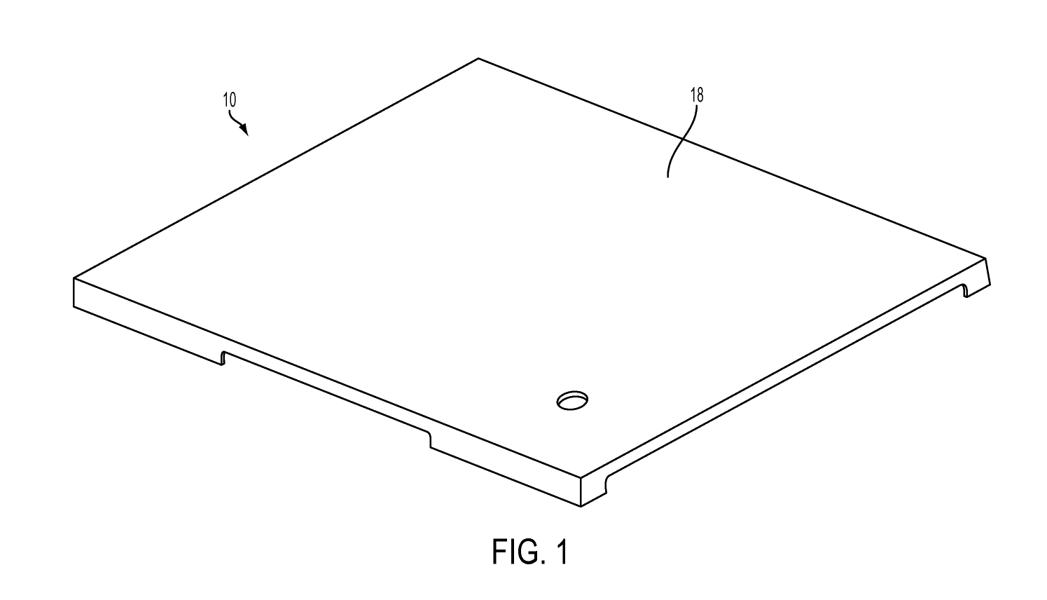

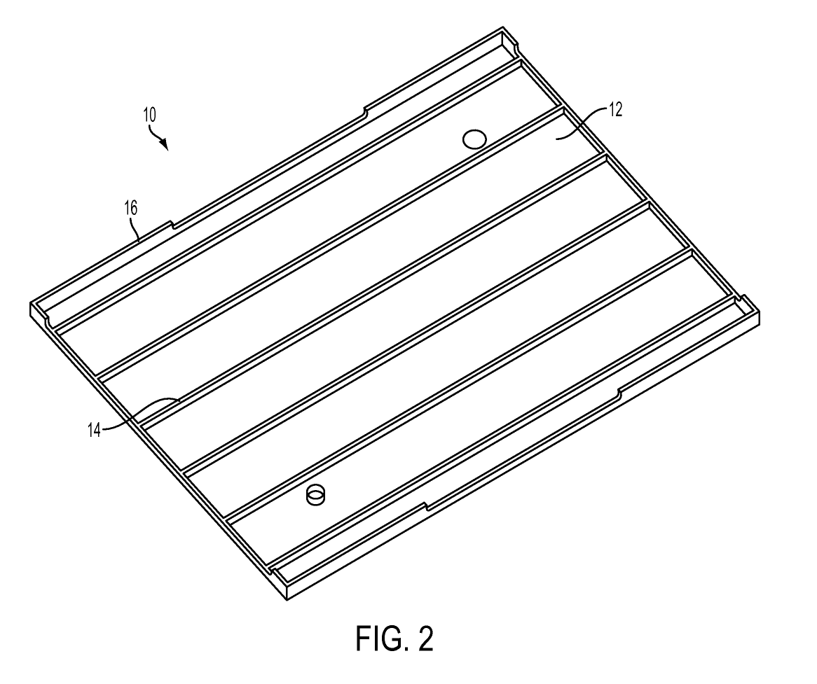

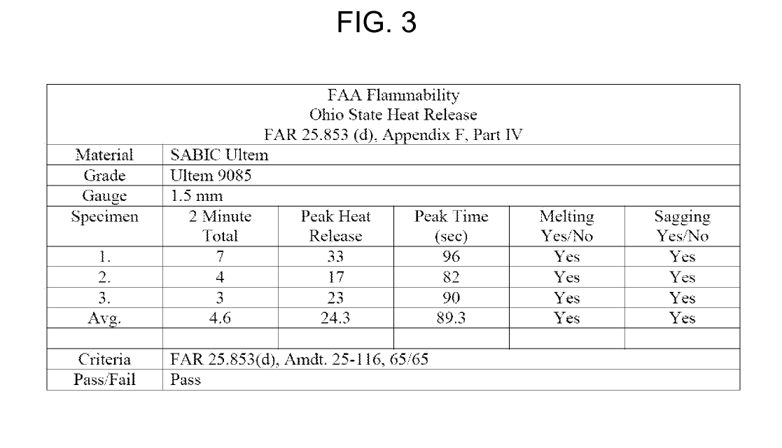

A test mold was built to evaluate the results of the microcellular molding process (and other injection molding processes) against conventional parts and whether the parts formed using the microcellular molding process would meet the above recited requirements. The mold geometry was configured with characteristics desirable in aircraft interior components including relatively thin walls with a relatively long flow length, and ribs of the same thickness as the abutting cosmetic wall. The geometry in the test mold is shown in FIGS. 1 and 2 to provide a rigid, monolithic, single layer article at test part 10. Specifically, the test part 10 was 12 inch by 9 inch by 0.51 inch overall, with nominal wall 12 having a thickness of 0.060 inches (1.5 mm). However, in other embodiments, the thickness of the nominal wall 12 may range from 1.25 mm to 1.8 mm. The part 10 included ribs 14 of 0.060 inches and slightly thicker side walls 16 of 0.070 inches. The mold itself was center sprue gated. The thermoplastic material used in testing was ULTEM 9085. Parts 10 were processed with conventional injection molding processes (i.e., without the use of microcellular foaming) and with the use of supercritical fluid (CO₂) as the foaming agent which is substantially saturated in the molten resin and which is molded under conditions that allow for cell nucleation and formation of a foamed material having a plurality of cells distributed through the part thereby resulting in the above noted weight reduction.

It was found that the microcellular foam structure resulting from the MUCELL™ microcellular foaming process effectively reduced the density of the plastic. Specifically, the microcellular foam parts 10 exhibited a preferred weight reduction of 8% to 18% relative to conventionally molded parts 10 from the same mold geometry and material. Furthermore, the microcellular foam parts exhibit an outer surface 18 substantially free of pinholes.

In addition, parts 10 with ribs 14 having the same thickness as the abutting wall 12 were produced with the supercritical foaming process with no discernable sink on surface 18 opposite the ribs 14. Parts 10 of the same geometry processed using the conventional injection molding process resulted in sink marks on surface 18 opposite the ribs 14, unless excessive packing pressure and hold times were employed. It is contemplated that this may provide relatively increased design flexibility to reduce weight with fewer concerns regarding the cosmetic effects of sink marks.

Typically, filling thin-walled injection molded parts may be a challenge as the material may freeze before it completely fills the mold cavity. Even when difficult to fill parts are filled completely there may be other adverse effects of the process. The microcellular foam process herein required significantly less (approximately 25% less) injection pressure as compared to the conventional injection molding process to fill the test mold for a thin-walled part. For example, first and second (packing) stage injection pressure for conventional injection molding was in the range of 1,700 psi. and 1,200 psi., respectively. However, for the microcellular foam process, first and second stage injection pressure was in the range of 1,237 psi. and 1,000 psi., respectively. Thus, microcellular foam processes potentially improves flow characteristics supporting relatively lower injection pressures and relatively longer flow-lengths. As a result, it is therefore contemplated that relatively thinner wall thickness may be achieved in injection molded parts for a given material using a microcellular foam molding process.

Furthermore, the molded parts using the microcellular foam process were tested relative to the safety requirements of FAR 25.853 and the heat-release standard OSU 65/65. The parts met the requirements of these standards. The results of the testing are shown in FIG. 3.

As shown in FIG. 3, microcellular foam part 10 has an average two minute heat release of less than or equal to 65 kw-min/m² when tested in accordance with the requirements of FAR 25.853 (d), Appendix F, Part IV through Amendment 25-116. More particularly, microcellular foam part 10 has an average two minute heat release of less than or equal to 50 kw-min/m² when tested in accordance with the requirements of FAR 25.853 (d), Appendix F, Part IV through Amendment 25-116. More particularly, microcellular foam part 10 has an average two minute heat release of less than or equal to 35 kw-min/m² when tested in accordance with the requirements of FAR 25.853 (d), Appendix F, Part IV through Amendment 25-116. More particularly, microcellular foam part 10 has an average two minute heat release of less than or equal to 20 kw-min/m² when tested in accordance with the requirements of FAR 25.853 (d), Appendix F, Part IV through Amendment 25-116. More particularly, microcellular foam part 10 has an average two minute heat release of less than or equal to 5 kw-min/m² when tested in accordance with the requirements of FAR 25.853 (d), Appendix F, Part IV through Amendment 25-116. More particularly, microcellular foam part 10 has an average two minute heat release of 4.6 kw-min/m² when tested in accordance with the requirements of FAR 25.853 (d), Appendix F, Part IV through Amendment 25-116.

As also shown in FIG. 3, microcellular foam part 10 has average peak heat release of less than or equal to 65 kw/m² when tested in accordance with the requirements of FAR 25.853 (d), Appendix F, Part IV through Amendment 25-116. More particularly, microcellular foam part 10 has average peak heat release of less than or equal to 50 kw/m² when tested in accordance with the requirements of FAR 25.853 (d), Appendix F, Part IV through Amendment 25-116. More particularly, microcellular foam part 10 has average peak heat release of less than or equal to 35 kw/m² when tested in accordance with the requirements of FAR 25.853 (d), Appendix F, Part IV through Amendment 25-116. More particularly, microcellular foam part 10 has average peak heat release of less than or equal to 25 kw/m² when tested in accordance with the requirements of FAR 25.853 (d), Appendix F, Part IV through Amendment 25-116. More particularly, microcellular foam part 10 has average peak heat release of 24.3 kw/m² when tested in accordance with the requirements of FAR 25.853 (d), Appendix F, Part IV through Amendment 25-116.

As also shown in FIG. 3, microcellular foam part 10 has an average time to peak heat release of more than 80 seconds when tested in accordance with the requirements of FAR 25.853 (d), Appendix F, Part IV through Amendment 25-116. More particularly, microcellular foam part 10 has an average time to peak heat release of more than 85 seconds when tested in accordance with the requirements of FAR 25.853 (d), Appendix F, Part IV through Amendment 25-116. More particularly, microcellular foam part 10 has an average time to peak heat release of 89 seconds when tested in accordance with the requirements of FAR 25.853 (d), Appendix F, Part IV through Amendment 25-116.

Test parts 10 produced using the microcellular foam process were subsequently painted with processes consistent with those used in the commercial aircraft interiors market. A finish was achieved on these parts without any mechanical surface preparation (e.g. filling and sanding) that did not transmit any imperfections resulting from the microcellular foam process.

In another embodiment of the present disclosure, microcellular foam part 10 may be extruded, which may be subsequently thermo-formed and/or vacuum-formed to provide a similar overall shape to FIGS. 1 and 2, albeit without ribs 14.

As may therefore be appreciated, microcellular foamed resins of selected resins now allows for one to manufacture and supply aircraft interior components, while maintaining the ability to satisfy aircraft material testing requirements. The parts herein also provide critical weight savings without significant sacrifice in other standard material testing performance characteristics, such as physical, thermal and chemical resistance features.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. An article comprising:
a rigid thermoplastic interior component for an aircraft, wherein the thermoplastic interior component has a microcellular foam structure,
wherein the thermoplastic interior component has an average two minute heat release of less than or equal to 65 kw-min/m² when tested in accordance with the requirements of FAR 25.853 (d), Appendix F, Part IV through Amendment 25-116; and
wherein the thermoplastic interior component has average peak heat release of less than or equal to 65 kw/m² when tested in accordance with the requirements of FAR 25.853 (d), Appendix F, Part IV through Amendment 25-116.

2. The article of claim 1 wherein:
the thermoplastic interior component is formed from a material composition having a melt flow index in the range of 1.0 g/10 min to 20.0 g/10 min when measured at 295° C./6.6 kgf in accordance with the requirements of ASTM D-1238-10.

3. The article of claim 1 wherein:
the thermoplastic interior component is formed from a material composition having a melt volume rate of 60 cm³/10 min to 70 cm³/10 min when measured at 360° C./5 kg in accordance with the requirements of ASTM D-1238-10.

4. The article of claim 1 wherein:
the thermoplastic interior component is formed from a material composition having a glass transition temperature greater than or equal to 50° C.

5. The article of claim 1 wherein:
the thermoplastic interior component is formed from a material composition comprising at least one polymer including polyetherimide, polyether ether ketone, polyimide, polyphenylene sulfide, polyphenylene sulfone, polyphenylsulfone and polycarbonate.

6. The article of claim 1 wherein:
the thermoplastic interior component is formed from a material composition comprising at least one copolymer.

7. The article of claim 1 wherein:
the thermoplastic interior component is formed from a material composition comprising a blend of two or more polymers.

8. The article of claim 1 wherein:
the thermoplastic interior component is formed from a material composition comprising a blend of polyetherimide and polycarbonate.

9. The article of claim 1 wherein:
the thermoplastic interior component exhibits a weight reduction of 5% to 20% relative to a solid component of a same geometry formed from a same material without the microcellular foam structure.

10. The article of claim 1 wherein:
the thermoplastic interior component is an injection molded component.

11. The article of claim 1 wherein:
the thermoplastic interior component is an extruded component.

12. The article of claim 1 wherein:
the thermoplastic interior component has an average time to peak heat release of more than 80 seconds when tested in accordance with the requirements of FAR 25.853 (d), Appendix F, Part IV through Amendment 25-116.

13. The article of claim 1 wherein:
the thermoplastic interior component has an average two minute heat release of less than or equal to 50 kw-min/m² when tested in accordance with the requirements of FAR 25.853 (d), Appendix F, Part IV through Amendment 25-116.

14. The article of claim 1 wherein:
the thermoplastic interior component has an average two minute heat release of less than or equal to 35 kw-min/m² when tested in accordance with the requirements of FAR 25.853 (d), Appendix F, Part IV through Amendment 25-116.

15. The article of claim 1 wherein:
the thermoplastic interior component has an average two minute heat release of less than or equal to 20 kw-min/m² when tested in accordance with the requirements of FAR 25.853 (d), Appendix F, Part IV through Amendment 25-116.

16. The article of claim 1 wherein:
the thermoplastic interior component has an average two minute heat release of less than or equal to 5 kw-min/m² when tested in accordance with the requirements of FAR 25.853 (d), Appendix F, Part IV through Amendment 25-116.

17. The article of claim 1 wherein:
the thermoplastic interior component has an average peak heat release of less than or equal to 50 kw/m² when tested in accordance with the requirements of FAR 25.853 (d), Appendix F, Part IV through Amendment 25-116.

18. The article of claim 1 wherein:
the thermoplastic interior component has an average peak heat release of less than or equal to 35 kw/m² when tested in accordance with the requirements of FAR 25.853 (d), Appendix F, Part IV through Amendment 25-116.

19. The article of claim 1 wherein:
the thermoplastic interior component has an average peak heat release of less than or equal to 25 kw/m² when tested in accordance with the requirements of FAR 25.853 (d), Appendix F, Part IV through Amendment 25-116.

20. A method of forming an article comprising:
forming a rigid thermoplastic interior component for an aircraft, wherein the thermoplastic interior component has a microcellular foam structure,
wherein the thermoplastic interior component has an average two minute heat release of less than or equal to 65 kw-min/m² when tested in accordance with the requirements of FAR 25.853 (d), Appendix F, Part IV through Amendment 25-116; and
wherein the thermoplastic interior component has an average peak heat release of less than or equal to 65 kw/m² when tested in accordance with the requirements of FAR 25.853 (d), Appendix F, Part IV through Amendment 25-116.
